(19) United States
(12) Patent Application Publication
(10) Pub. No.: US 2025/0009576 A1
(43) Pub. Date: Jan. 9, 2025

(54) TWO-STEP FOLDABLE WALKING ASSIST APPARATUS

(71) Applicant: ORBITN CO., LTD., Seoul (KR)

(72) Inventor: Kyungae CHA, Seoul (KR)

(21) Appl. No.: 18/225,167

(22) Filed: Jul. 24, 2023

(30) Foreign Application Priority Data
Jul. 4, 2023 (KR) 10-2023-0086473

(51) Int. Cl. A61G 5/08; A61G 5/10

(52) U.S. Cl. CPC A61G 5/0833; A61G 5/085; A61G 5/101; A61G 5/022

(57) ABSTRACT

A disclosed two-step foldable walking assist apparatus may include first and second main frames, first and second rear support frames respectively coupled to middle portions of the first and second main frames, a seat member installed between the first and second main frames and connected to all the first and second main frames and the first and second rear support frames, and first and second folding parts disposed at positions higher than the first and second rear support frames and respectively provided on the first and second main frames.

### CROSS-REFERENCE TO RELATED APPLICATION

This application claims priority to and the benefit of Korean Patent Application No. 10-2023-0086473 filed in the Korean Intellectual Property Office on Jul. 4, 2023, the entire contents of which are incorporated herein by reference.

### BACKGROUND

### Technical Field

The present invention relates to a device and method related to walking/mobility, and more particularly, to a walking assist apparatus and a related method that old and weak persons may use.

### Background Art

With the rapid increase in population of old people, it is expected that industries and related markets, which provide goods or services to old people, will be significantly expanded. There is a rapidly increasing demand for products that support/assist independent living/activities of old and weak persons or are required for exercise, injury prevention, and the like. A walking assistant, which is a mobility assistant, is one of the products. The walking assistants are products that are required not only by old people who suffer from aging symptoms such as weakness of muscular strength of lower limb and waist, poor balance, and musculoskeletal diseases, but also by persons who need walking assistance due to injuries or the like. The demand for the walking assistant is consistently increasing.

However, the walking assistant in the related art mostly has a structure configured by connecting steel frames, has a significantly large volume, and is comparatively vulnerable to impact. For this reason, the walking assistant may have many disadvantages in terms of logistical movements such as transportation, delivery, and shipping. In addition, from the point of view of the user, the walking assistant needs to be compactly accommodated and stored. However, the walking assistant in the related art may hardly satisfy the requirements of the consumer. Further, the walking assistant in the related art may have a problem in which the convenience of use and safety deteriorate.

Accordingly, there is a need to develop a walking assist apparatus capable of ensuring the convenience of use and safety and having advantages in terms of logistical movements, accommodation, and storage.

### SUMMARY

The present invention has been made in an effort to provide a walking assist apparatus capable of ensuring the convenience of use and safety and having significant advantages in terms of logistical movements, accommodation, and storage.

Technical problems to be solved by the present invention are not limited to the above-mentioned technical problems, and other technical problems, which are not mentioned above, may be clearly understood by those skilled in the art from the following descriptions.

An exemplary embodiment of the present invention provides a two-step foldable walking assist apparatus including: first and second main frames spaced apart from each other, extending in parallel with each other in an upward/downward direction, and each having an inclined structure inclined rearward; first and second rear support frames respectively coupled to middle portions of the first and second main frames, extending downward in parallel with each other, and each having an inclined structure inclined forward; a handle part provided to be connected to upper ends of the first and second main frames; first and second front wheel parts coupled to lower ends of the first and second main frames or portions adjacent to the lower ends of the first and second main frames; first and second rear wheel parts coupled to lower ends of the first and second rear support frames or portions adjacent to the lower ends of the first and second rear support frames; a seat member installed between the first and second main frames and connected to all the first and second main frames and the first and second rear support frames; and first and second folding parts disposed at positions higher than the first and second rear support frames and respectively provided on the first and second main frames, in which the two-step foldable walking assist apparatus is configured to be folded by raising a front portion of the seat member and allowing lower portions of the first and second main frames and lower portions of the first and second rear support frames to move toward one another, and in which the first and second main frames are configured to be folded forward and downward at the first and second folding parts.

The two-step foldable walking assist apparatus may include: a first connection member coupled to the first main frame and the first rear support frame to connect the first main frame and the first rear support frame; and a second connection member coupled to the second main frame and the second rear support frame to connect the second main frame and the second rear support frame, in which the seat member is coupled to the first and second connection members and disposed between the first and second connection members.

The first folding part may include: a lower assembling member; an upper assembling member coupled to the lower assembling member by a rotary shaft member and provided to be rotatable about the rotary shaft member relative to the lower assembling member; and a clutch member installed on the lower assembling member and structurally coupled to a part of the upper assembling member, the clutch member being configured to restrict or allow a rotational motion of the upper assembling member, and the first main frame may be configured to be folded at the first folding part by a rotation of the upper assembling member.

The second folding part and the first folding part may have the same configuration or a symmetric configuration.

The two-step foldable walking assist apparatus may further include: a brake lever disposed below the handle part and connected to at least one of the first and second main frames, the brake lever being configured to brake at least one of the first and second rear wheel parts, in which the brake lever performs a hand brake function while the two-step foldable walking assist apparatus travels, and the brake lever performs a parking brake function while the two-step foldable walking assist apparatus is parked.

The two-step foldable walking assist apparatus may further include: a storage member disposed below the seat member and made of a flexible material.

The two-step foldable walking assist apparatus may further include: steering adjustment members configured to control rotation ranges for steering the first and second front wheel parts.

The two-step foldable walking assist apparatus may further include a backrest connection frame disposed between the seat member and the handle part and configured to connect the first and second main frames.

According to the embodiments of the present invention, it is possible to implement the walking assist apparatus capable of ensuring the convenience of use and safety and having significant advantages in terms of logistical movements, accommodation, and storage. The walking assist apparatus according to the embodiments has the two-step foldable structure, i.e., the structure capable of being folded twice, which may provide many advantages in terms of logistical movements such as shipping, delivery, and transportation and enable compact accommodation/storage even for the user. Further, the walking assist apparatus according to the embodiments may provide excellent convenience of use and safety.

However, the effect of the present invention is not limited to the above-mentioned effects but may be variously expanded without departing from the technical spirit and scope of the present invention.

### BRIEF DESCRIPTION OF THE DRAWINGS

FIGS. 1 to 3 are perspective views illustrating a two-step foldable walking assist apparatus according to an embodiment of the present invention.

FIGS. 4A to 4D are images illustrating a process of folding the two-step foldable walking assist apparatus according to the embodiment of the present invention.

FIGS. 5 to 7 are perspective views illustrating a state in which the two-step foldable walking assist apparatus according to the embodiment of the present invention is folded (folded twice).

FIG. 8 is a perspective view illustrating a specific configuration that may be adopted to a folding part applicable to the two-step foldable walking assist apparatus according to the embodiment of the present invention.

FIGS. 9 and 10 are perspective views illustrating a case in which an upper assembling member rotates about a rotary shaft member relative to a lower assembling member after a clutch member is unlocked from the folding part in FIG. 8.

FIG. 11 is a view for explaining a method of adjusting a height of the walking assist apparatus according to the embodiment of the present invention.

FIG. 12 is a view for explaining a method of performing a hand brake function of the walking assist apparatus according to the embodiment of the present invention.

FIG. 13 is a view for explaining a method of performing a parking brake function of the walking assist apparatus according to the embodiment of the present invention.

FIG. 14 is a view for explaining a method of controlling and steering the walking assist apparatus according to the embodiment of the present invention.

FIG. 15 is a perspective view for explaining a two-step foldable walking assist apparatus according to another embodiment of the present invention.

### DETAILED DESCRIPTION

Hereinafter, embodiments of the present invention will be described in detail with reference to the accompanying drawings.

The embodiments of the present invention to be described below are provided to more clearly explain the present invention to those skilled in the art. The scope of the present invention is not limited to the following embodiments, and the following embodiments may be modified in various other forms.

The terms used in the present specification are for explaining the particular embodiments, not for limiting the present invention. The singular expressions used in the present specification may include the plural expressions unless the context clearly dictates otherwise. The terms “comprise (include)” and/or “comprising (including)” used in the present specification are intended to specify the presence of the mentioned shapes, steps, numbers, operations, members, elements, and/or groups thereof, but do not exclude presence or addition of one or more other shapes, steps, numbers, operations, members, elements, and/or groups thereof. In addition, the terms “connected.” “connecting.” and the like used in the present specification are intended to mean not only that certain members are directly connected, but also that the members are indirectly connected as another member is further interposed between the members.

In the specification of the present application, when one member is disposed “on” another member, this includes not only a case where the one member is brought into contact with another member, but also a case where still another member is present between the two members. The term “and/or” used in the present specification includes any one, one or more, or all the combinations of listed related items. Words of degree, such as “about”, “substantially”, and the like are used throughout the specification of the present application in the sense of “at, or nearly at, when given the manufacturing, design, and material tolerances inherent in the stated circumstances” and are used to prevent the infringer from unfairly taking advantage of the present invention where exact or absolute figures and operational or structural relationships are stated as an aid to understanding the present invention.

Hereinafter, the embodiments of the present invention will be described in detail with reference to the accompanying drawings. The sizes or thicknesses of the regions or parts illustrated in the accompanying drawings may be somewhat exaggerated for the clarity of the specification and the convenience of description. Throughout the detailed description, like reference numerals indicate like components throughout the specification.

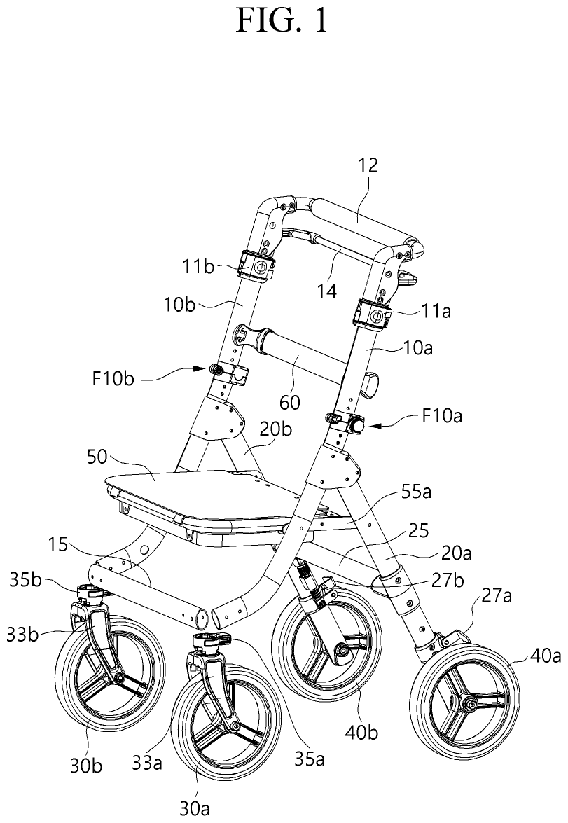

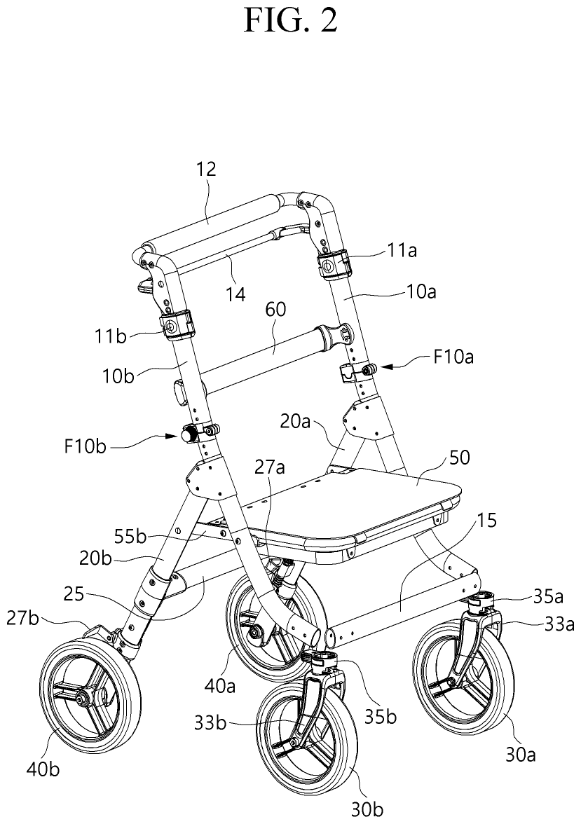

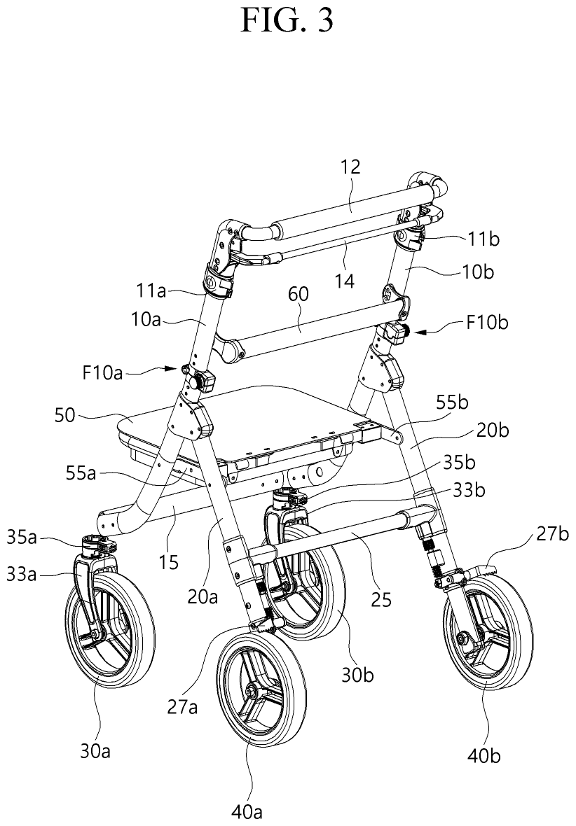

FIGS. 1 to 3 are perspective views illustrating a two-step foldable walking assist apparatus according to an embodiment of the present invention. FIGS. 1 to 3 illustrates the walking assist apparatus in a non-folded state. The walking assist apparatus may be referred to as a ‘walking assist vehicle’ or a ‘walking assistant’.

With reference to FIGS. 1 to 3, the walking assist apparatus according to the embodiment of the present invention may include first and second main frames 10a and 10b spaced apart from each other, extending in parallel with each other in an upward/downward direction, and each having an inclined structure inclined rearward. The first and second main frames 10a and 10b may be inclined rearward as a whole, thereby defining a predetermined curved structure. A lower end of each of the first and second main frames 10a and 10b may be disposed forward of an upper end of each of the first and second main frames 10a and 10b. The first main frame 10a may be referred to as a first main column part or a first main column frame part, and the second main frame 10b may be referred to as a second main column part or a second main column frame part. The walking assist apparatus may include a handle part 12 provided to connect to upper ends of the first and second main frames 10a and 10b. The handle part 12 may have a structure that connects the upper end of the first main frame 10a and the upper end of the second main frame 10b.

The walking assist apparatus may include first and second rear support frames 20a and 20b respectively connected to middle portions of the first and second main frames 10a and 10b. The first and second rear support frames 20a and 20b extend downward in parallel with each other and each having an inclined structure inclined forward. The first and second rear support frames 20a and 20b may be respectively coupled to rear sides of approximately central portions of the first and second main frames 10a and 10b. The first and second rear support frames 20a and 20b may be coupled to be respectively rotatable relative to the first and second main frames 10a and 10b. The first rear support frame 20a may be referred to as a first rear support rod, and the second rear support frame 20b may be referred to as a second rear support rod.

The walking assist apparatus may include first and second front wheel parts 30a and 30b coupled (connected) to the lower ends of the first and second main frames 10a and 10b or portions adjacent to the lower ends of the first and second main frames 10a and 10b. In addition, the walking assist apparatus may include first and second rear wheel parts 40a and 40b coupled (connected) to the lower ends of the first and second rear support frames 20a and 20b or portions adjacent to the lower ends of the first and second rear support frames 20a and 20b.

The walking assist apparatus may include a seat member 50 installed between the first and second main frames 10a and 10b and connected to all the first and second main frames 10a and 10b and the first and second rear support frames 20a and 20b. The seat member 50 may be installed at a height lower than heights of the upper ends of the first and second rear support frames 20a and 20b. The seat member 50 may have a flat or approximately flat plate shape. A person may be seated on the seat member 50, or an item may be placed on the seat member 50.

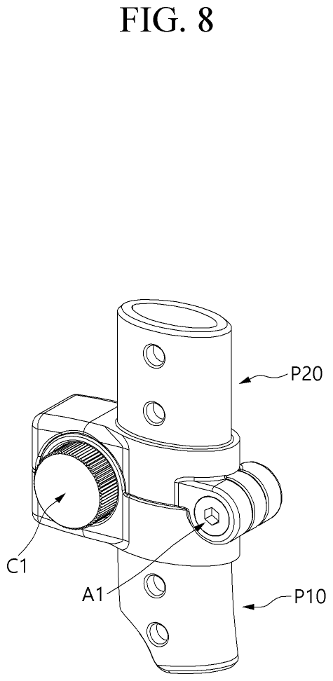

The walking assist apparatus may include first and second folding parts F10a and F10b respectively provided on the first and second main frames 10a and 10b and disposed at positions higher than the first and second rear support frames 20a and 20b. The first and second folding parts F10a and F10b may be respectively provided adjacent to the upper ends of the first and second rear support frames 20a and 20b. The first main frame 10a may be folded at the first folding part F10a, and the second main frame 10b may be folded at the second folding part F10b. The specific structures of the first and second folding parts F10a and F10b will be described in detail later with reference to FIGS. 8 to 10.

The walking assist apparatus according to the embodiment of the present invention may be configured to be folded by raising a front portion of the seat member 50 and moving lower portions of the first and second main frames 10a and 10b and lower portions of the first and second rear support frames 20a and 20b toward one another. In addition, the first and second main frames 10a and 10b may be folded forward and downward at the first and second folding parts F10a and F10b. Therefore, the walking assist apparatus may have a structure capable of being folded twice, such that the walking assist apparatus may be folded in a significantly compact manner. The walking assist apparatus may be referred to as a two-step foldable walking assist apparatus.

According to the embodiment, the walking assist apparatus may further include a first connection member 55a coupled to the first main frame 10a and the first rear support frame 20a to connect the first main frame 10a and the first rear support frame 20a, and a second connection member 55b coupled to the second main frame 10b and the second rear support frame 20b to connect the second main frame 10b and the second rear support frame 20b. In this case, the seat member 50 may be coupled to and disposed between the first and second connection members 55a and 55b. In addition, the first and second connection members 55a and 55b may be configured to support at least a part of the seat member 50. When the front portion of the seat member 50 is raised, the first and second connection members 55a and 55b may rotate, and intervals between the lower portions of the first and second main frames 10a and 10b and the lower portions of the first and second rear support frames 20a and 20b may be decreased.

According to the embodiment, the walking assist apparatus may further include a brake lever 14 disposed below the handle part 12 and provided to be connected to at least one of the first and second main frames 10a and 10b in order to brake at least one of the first and second rear wheel parts 40a and 40b. For example, the brake lever 14 may be installed to be connected to both the first and second main frames 10a and 10b and configured to brake the first and second rear wheel parts 40a and 40b. In this regard, a first braking unit 27a for braking the first rear wheel part 40a may be disposed in a region adjacent to the first rear wheel part 40a, and a second braking unit 27b for braking the second rear wheel part 40b may be disposed in a region adjacent to the second rear wheel part 40b. The first braking unit 27a may be installed to be connected to the first rear support frame 20a, and the second braking unit 27b may be installed to be connected to the second rear support frame 20b. The first and second braking units 27a and 27b may operate in conjunction with the brake lever 14.

According to the embodiment, the brake lever 14 may serve as a hand brake while the walking assist apparatus travels, and the brake lever 14 may serve as a parking brake while the walking assist apparatus is parked. In the case of the hand brake function while the walking assist apparatus travels, the walking assist apparatus may be braked when a user pulls the brake lever 14, and the walking assist apparatus may be released when the user releases the brake lever 14. In the case of the parking brake function while the walking assist apparatus is parked, the braked state may be fixed as the brake lever 14 is fixed at a lower side when the user pushes and moves the brake lever 14 downward. In this state, the fixed braked state may be released when the user moves the brake lever 14 upward. The convenience of use and safety of the walking assist apparatus according to the embodiment may be improved by the function and operating method of the brake lever 14.

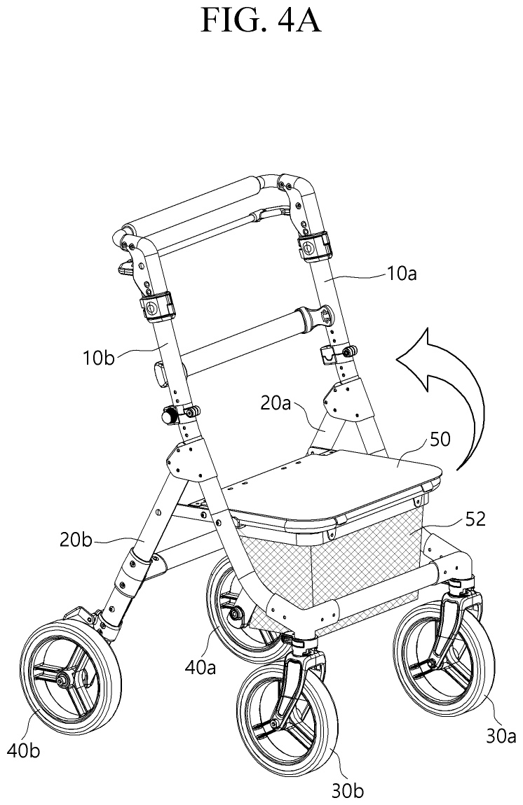

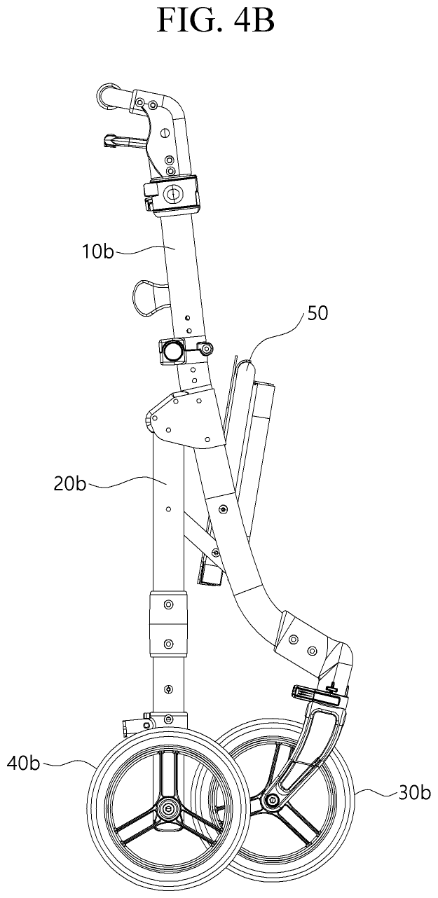

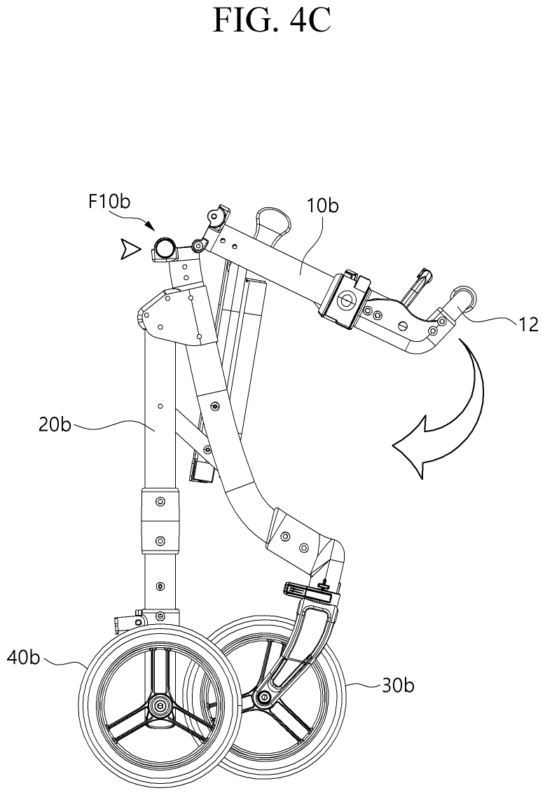

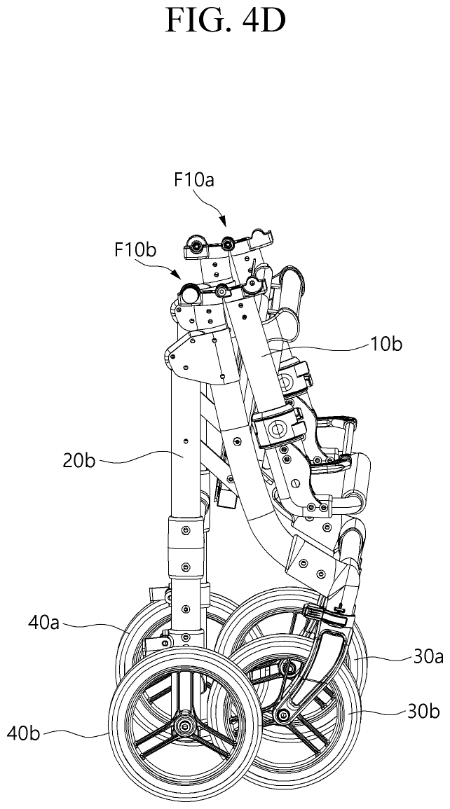

According to the embodiment, the walking assist apparatus may further include a storage member (not illustrated) (see 52 in FIG. 4A) disposed below the seat member 50. The storage member may be made of a flexible material. The storage member may be provided in the form of a basket, a pocket, or the like. The seat member 50 may serve as a lid (door) for the storage member and have a waterproof function. Various items may be easily stored in the storage member. In addition, the storage member may be made of a flexible material, which may not cause an inconvenience in folding the walking assist apparatus. In some instances, the storage member may be provided to be attachable and detachable.

According to the embodiment, the walking assist apparatus may further include steering adjustment members 35a and 35b configured to control rotation ranges for steering the first and second front wheel parts 30a and 30b. The first steering adjustment member 35a may be provided to control the rotation range for steering the first front wheel part 30a, and the second steering adjustment member 35b may be provided to control the rotation range for steering the second front wheel part 30b. The walking assist apparatus may further include the first and second wheel coupling members 33a and 33b extending downward and coupled to the lower ends of the first and second main frames 10a and 10b or portions adjacent to the lower ends of the first and second main frames 10a and 10b. The first and second steering adjustment members 35a and 35b may be installed to be respectively coupled to the first and second wheel coupling members 33a and 33b. By using the first steering adjustment member 35a, the rotation range of the first front wheel part 30a may be adjusted to be decreased or increased or the first front wheel part 30a may be fixed so as not to be rotated (i.e., 0°). Likewise, by using the second steering adjustment member 35b, the rotation range of the second front wheel part 30b may be adjusted to be decreased or increased or the second front wheel part 30b may be fixed so as not to be rotated (i.e., 0°). Therefore, the convenience of use and safety of the walking assist apparatus according to the embodiment may be improved by the steering adjustment members 35a and 35b.

According to the embodiment, the walking assist apparatus may further include a backrest connection frame 60 disposed between the seat member 50 and the handle part 12 to connect the first and second main frames 10a and 10b. The backrest connection frame 60 may be disposed between the handle part 12 and the folding parts F10a and F10b and provided to be closer to the folding parts F10a and F10b. When a person is seated on the seat member 50 or an item is placed on the seat member 50, the backrest connection frame 60 may serve as a backrest or a lateral stand. In addition, the backrest connection frame 60 may serve to securely support the structure of the walking assist apparatus.

According to the embodiment, the walking assist apparatus may further include first and second height fixing members 11a and 11b disposed in regions adjacent to the upper ends of the first and second main frames 10a and 10b. The first and second main frames 10a and 10b may be configured to adjust heights of the first and second height fixing members 11a and 11b in the upward direction. The first and second height fixing members 11a and 11b may serve to fix the adjusted heights. Therefore, it is possible to easily control the heights of the first and second main frames 10a and 10b depending on the user's height, body type, and the like.

The walking assist apparatus may further include a first auxiliary connection frame 15 configured to connect the lower end of the first main frame 10a or a region adjacent to the lower end of the first main frame 10a to the lower end of the second main frame 10b or a region adjacent to the lower end of the second main frame 10b. In addition, the walking assist apparatus may further include a second auxiliary connection frame 25 disposed between the first rear support frame 20a and the second rear support frame 20b to connect the first rear support frame 20a and the second rear support frame 20b. The structure of the walking assist apparatus may become more robust by the first and second auxiliary connection frames 15 and 25.

FIGS. 4A to 4D are images illustrating a process of folding the two-step foldable walking assist apparatus according to the embodiment of the present invention.

With reference to FIGS. 4A and 4B, when the user holds the front portion of the seat member 50 of the walking assist apparatus according to the embodiment with his/her hand and raises the front portion of the seat member 50, a main body of the apparatus may stand vertically so that the lower portions of the first and second main frames 10a and 10b and the lower portions of the first and second rear support frames 20a and 20b approach one another. FIG. 4B illustrates a state in which the walking assist apparatus is folded in a first step. In this case, the first and second front wheel parts 30a and 30b may be partially disposed between the first and second rear wheel parts 40a and 40b and partially overlap the first and second rear wheel parts 40a and 40b in a transverse direction.

With reference to FIGS. 4C and 4D, in a state in which clutch members of the first and second folding parts F10a and F10b are unlocked, the user may hold the handle part 12 and lower the handle part 12 toward the front lower side of the walking assist apparatus. The first and second main frames 10a and 10b may be folded at the first and second folding parts F10a and F10b. FIG. 4D illustrates a state in which the two-step folding process is completed. Because the walking assist apparatus is folded by the two-step folding process, the walking assist apparatus may be folded in a significantly compact manner and very convenient to move and store. The folded walking assist apparatus may be very slim and autonomously stand.

Meanwhile, a process of unfolding the walking assist apparatus may be performed reversely to the process described with reference to FIGS. 4A to 4D.

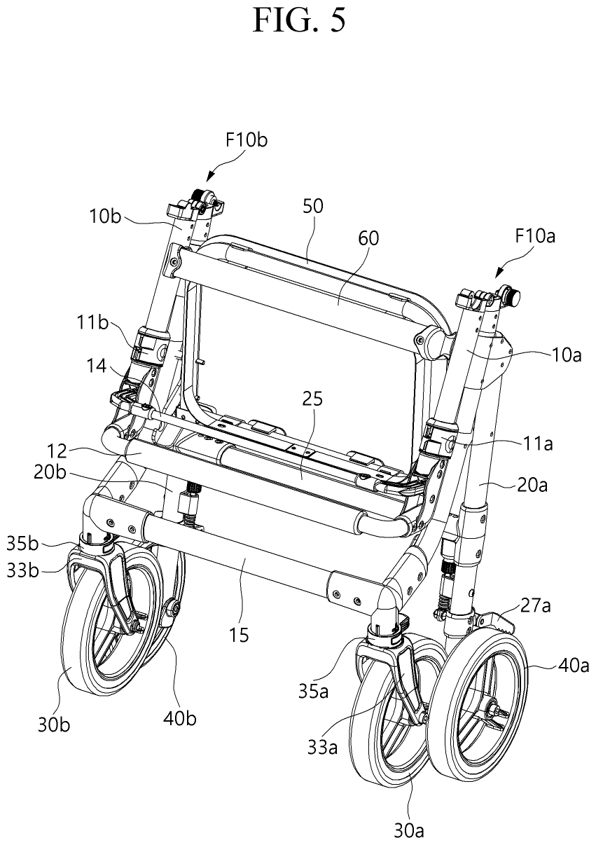

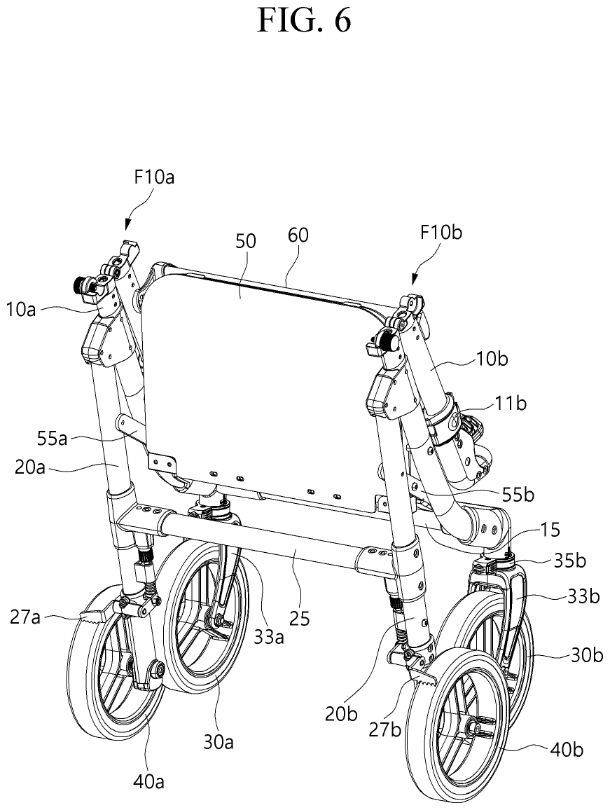

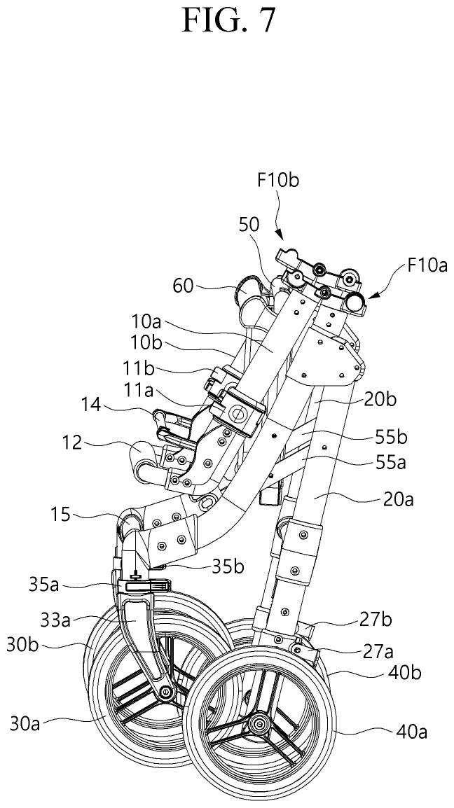

FIGS. 5 to 7 are perspective views illustrating a state in which the two-step foldable walking assist apparatus according to the embodiment of the present invention is folded (folded twice).

With reference to FIGS. 5 to 7, the walking assist apparatus according to the present embodiment may be configured to be folded by raising the front portion of the seat member 50 and moving the lower portions of the first and second main frames 10a and 10b and the lower portions of the first and second rear support frames 20a and 20b toward one another. In addition, the walking assist apparatus may be configured such that the first and second main frames 10a and 10b may be folded forward and downward at the first and second folding parts F10a and F10b. The walking assist apparatus may have a structure capable of being folded twice, such that the walking assist apparatus may be folded in a significantly compact manner.

In this case, the first and second front wheel parts 30a and 30b may be partially disposed between the first and second rear wheel parts 40a and 40b and partially overlap the first and second rear wheel parts 40a and 40b in the transverse direction. In this regard, the first and second front wheel parts 30a and 30b may be respectively disposed below (immediately below) the first and second main frames 10a and 10b, and the first and second rear wheel parts 40a and 40b may be disposed outside the first and second rear support frames 20a and 20b in the transverse direction. The first rear wheel part 40a may be disposed outside the first rear support frame 20a in the transverse direction, and the second rear wheel part 40b may be disposed outside the second rear support frame 20b in the transverse direction. Therefore, when the walking assist apparatus is folded, the first and second front wheel parts 30a and 30b may be partially disposed between the first and second rear wheel parts 40a and 40b and partially overlap the first and second rear wheel parts 40a and 40b in the transverse direction.

FIG. 8 is a perspective view illustrating a specific configuration that may be adopted to the folding part applicable to the two-step foldable walking assist apparatus according to the embodiment of the present invention.

With reference to FIG. 8, the folding part applicable to the walking assist apparatus according to the present embodiment may include a lower assembling member P10, an upper assembling member P20 coupled to the lower assembling member P10 by a rotary shaft member A1, and a clutch member C1 installed on the lower assembling member P10 and provided to be structurally coupled to a part of the upper assembling member P20. The upper assembling member P20 may be provided to be rotatable about the rotary shaft member A1 relative to the lower assembling member P10. The clutch member C1 may be provided to restrict or allow a rotational motion of the upper assembling member P20. According to a non-restrictive example, the clutch member C1 may have a kind of valve structure and configured to restrict or allow the rotational motion of the upper assembling member P20 by locking or unlocking the valve. The main frame may be folded at the folding part by the rotation of the upper assembling member P20. A first part of the main frame may be coupled to the lower assembling member P10, and a second part of the main frame may be coupled to the upper assembling member P20.

The folding part, which has been described with reference to FIG. 8, may be applied to the first and second folding parts F10a and F10b described with reference to FIGS. 1 to 3. The first and second folding parts F10a and F10b may have the same configuration or a symmetric configuration. However, the specific configuration of the folding part described with reference to FIG. 8 may be provided for illustrative purposes and changed in some instances.

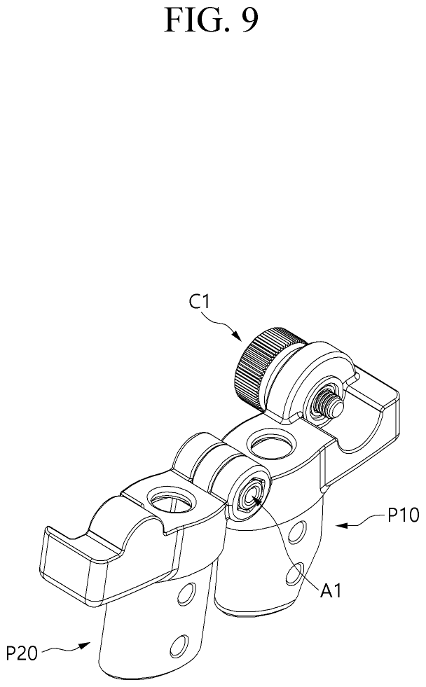

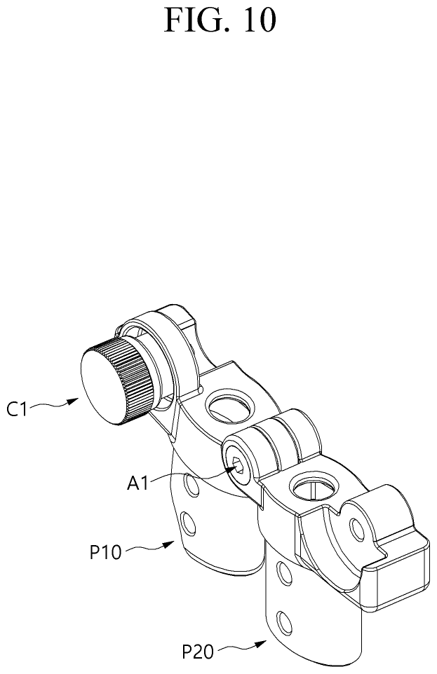

FIGS. 9 and 10 are perspective views illustrating a case in which the upper assembling member P20 rotates about the rotary shaft member A1 relative to the lower assembling member P10 after the clutch member C1 is unlocked from the folding part in FIG. 8.

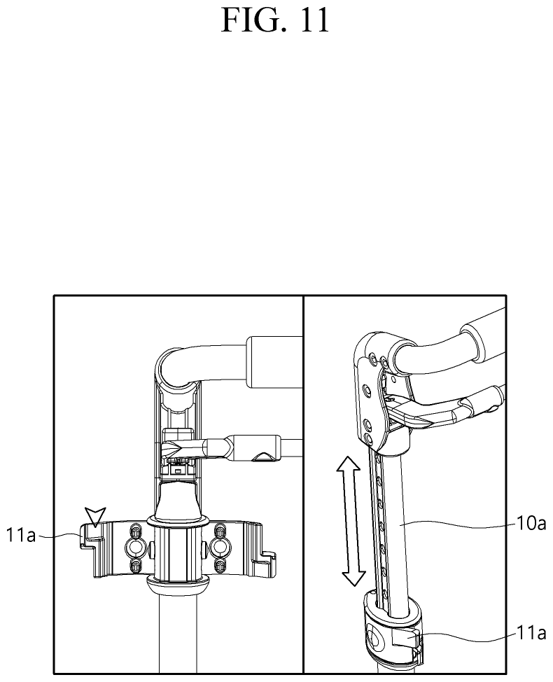

FIG. 11 is a view for explaining a method of adjusting a height of the walking assist apparatus according to the embodiment of the present invention.

With reference to FIG. 11, the first main frame 10a may be configured such that a height thereof may be adjusted upward from the first height fixing member 11a. The first height fixing member 11a may serve to fix the adjusted height. After the first height fixing member 11a is loosened, the height of the first main frame 10a may be adjusted, and then the first height fixing member 11a may be closed and fixed. This height adjustment method may also be applied to the second main frame (10b in FIG. 1) in the same way. It is possible to easily adjust the heights of the first and second main frames 10a and 10b depending on the user's height, body type, and the like.

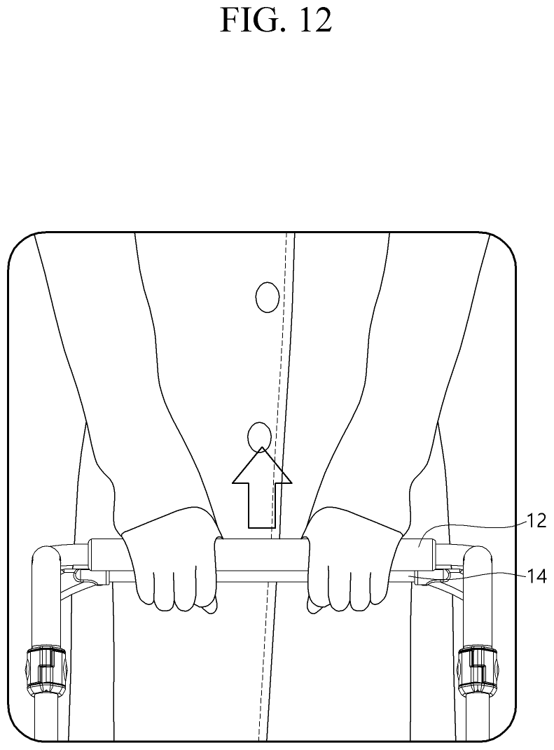

FIG. 12 is a view for explaining a method of performing the hand brake function of the walking assist apparatus according to the embodiment of the present invention.

With reference to FIG. 12, in the case of the hand brake function, the walking assist apparatus may be braked when the user pulls the brake lever 14, and the braking of the walking assist apparatus may be released when the user releases the brake lever 14.

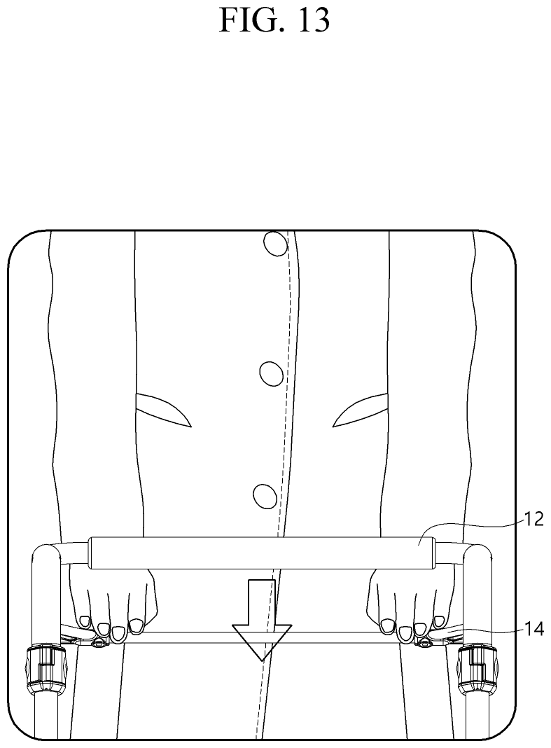

FIG. 13 is a view for explaining a method of performing the parking brake function of the walking assist apparatus according to the embodiment of the present invention.

With reference to FIG. 13, in the case of the parking brake function, the braked state may be fixed as the brake lever 14 is fixed at the lower side when the user pushes and moves the brake lever 14 downward. In this state, the fixed braked state may be released when the user moves the brake lever 14 upward.

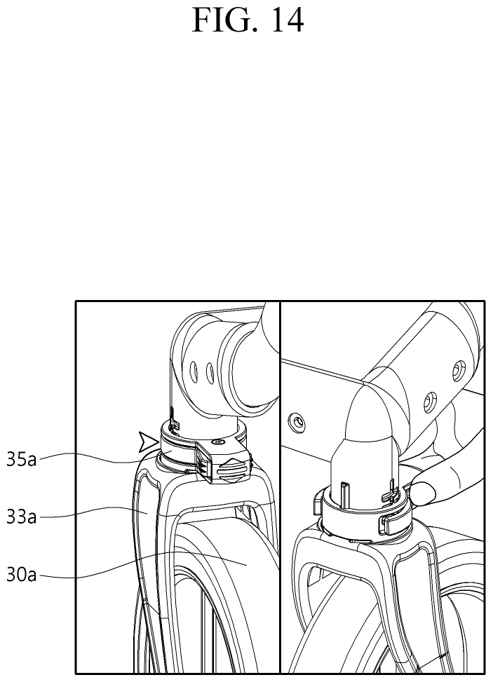

FIG. 14 is a view for explaining a method of controlling and steering the walking assist apparatus according to the embodiment of the present invention.

With reference to FIG. 14, the rotation range of the first front wheel part 30a may be adjusted to be decreased or increased by using the first steering adjustment member 35a, or the first front wheel part 30a may be fixed so as not to be rotated (i.e., 0°) by using the first steering adjustment member 35a. Likewise, by using the second steering adjustment member 35b, the rotation range of the second front wheel part (30b in FIG. 1) may be adjusted to be decreased or increased or the second front wheel part 30b may be fixed so as not to be rotated (i.e., 0°). Therefore, the steering control may be easily performed on the front wheel parts 30a and 30b.

According to the embodiment, the walking assist apparatus may have a predetermined sensor and an electronic brake device. A function of improving pedestrian safety is provided on the basis of the sensor.

According to an example, pressure sensors may be provided in the first front wheel part 30a, the second front wheel part 30b, the first rear wheel part 40a, and the second rear wheel part 40b. The first front wheel part 30a, the second front wheel part 30b, the first rear wheel part 40a, and the second rear wheel part 40b may be controlled on the basis of pressure acquired by the provided pressure sensors. More specifically, the first rear wheel part 40a and the second rear wheel part 40b may be braked so as not to rotate in case that an average value of a first pressure acquired by a first pressure sensor provided in the first front wheel part 30a and a second pressure acquired by a second pressure sensor provided in the second front wheel part 30b is a first critical value or less and an average value of a third pressure acquired by a third pressure sensor provided in the first rear wheel part 40a and a fourth pressure acquired by a fourth pressure sensor provided in the second rear wheel part 40b is a second critical value or more. Therefore, when a pedestrian falls down backward while holding the handle parts 12a and 12b, the above-mentioned pressure distribution may occur on the wheel parts. In this case, the first rear wheel part 40a and the second rear wheel part 40b may be automatically braked so as not to rotate, thereby improving the stability of the pedestrian.

In another embodiment, the first front wheel part 30a and the second front wheel part 30b may be braked so as not to rotate in case that the average value of the first pressure acquired by the first pressure sensor provided in the first front wheel part 30a and the second pressure acquired by the second pressure sensor provided in the second front wheel part 30b is the third critical value or more and the average value of the third pressure acquired by the third pressure sensor provided in the first rear wheel part 40a and the fourth pressure acquired by the fourth pressure sensor provided in the second rear wheel part 40b is the fourth critical value or less. In this case, the front wheels are braked in a situation in which a pedestrian falls down forward on a downward slope or the like, thereby providing a means capable of improving the stability of the pedestrian.

According to another example, the walking assist apparatus electronically brakes the first front wheel part 30a, the second front wheel part 30b, the first rear wheel part 40a, and the second rear wheel part 40b on the basis of a walking pattern of the pedestrian, thereby providing the safety to the user. More specifically, the walking assist apparatus may determine an average walking speed of the pedestrian through the walking pattern of the pedestrian on the basis of a provided speed sensor (e.g., a sensor provided in the wheel and configured to detect a rotational speed for each time). In case that a real-time speed of the walking assist apparatus is higher than an average walking speed of the pedestrian by a predetermined critical value or more, the first front wheel part 30a, the second front wheel part 30b, the first rear wheel part 40a, and the second rear wheel part 40b may be electronically braked at a predetermined level, thereby allowing the pedestrian to walk within a predetermined speed range. In this process, the walking assist apparatus is braked by the acceleration with a predetermined magnitude or lower, thereby providing a means capable of allowing the pedestrian to walk while gradually decreasing the speed.

According to still another example, gravity sensors may be provided in the first front wheel part 30a, the second front wheel part 30b, the first rear wheel part 40a, and the second rear wheel part 40b. The first front wheel part 30a, the second front wheel part 30b, the first rear wheel part 40a, and the second rear wheel part 40b may be controlled on the basis of pressure acquired by the gravity sensors provided in the walking assist apparatus. More specifically, in case that it is determined by the gravity sensors that positions of the first front wheel part 30a and the second front wheel part 30b are higher than positions of the first rear wheel part 40a and the second rear wheel part 40b by a predetermined critical value or more, the walking assist apparatus may support the walking of the pedestrian, who moves on an upward slope, by providing predetermined power to the first front wheel part 30a, the second front wheel part 30b, the first rear wheel part 40a, and the second rear wheel part 40b.

On the contrary, in case that it is determined by the gravity sensors that the positions of the first front wheel part 30a and the second front wheel part 30b are lower than the positions of the first rear wheel part 40a and the second rear wheel part 40b by a predetermined critical value or more, the walking assist apparatus may provide a means for assisting the safety of the pedestrian, who moves downward on a downward slope, by braking the first front wheel part 30a, the second front wheel part 30b, the first rear wheel part 40a, and the second rear wheel part 40b at a predetermined level.

In addition, in case that a rate of change in pressure detected by the pressure sensors in the first front wheel part 30a, the second front wheel part 30b, the first rear wheel part 40a, and the second rear wheel part 40b is detected in a predetermined cycle or more, the walking assist apparatus may assist the safety of the pedestrian, who walks on a road with an uneven road surface, by braking the first front wheel part 30a, the second front wheel part 30b, the first rear wheel part 40a, and the second rear wheel part 40b at a predetermined level.

In case that a force for braking exceeds a predetermined braking force critical value (here, the braking force critical value is determined as a value smaller than a maximum braking force) during an electronically braking process, the walking assist apparatus may generate notification sound, thereby preventing a situation in which the pedestrian cannot be braked.

The walking assist apparatus may further include a predetermined computing device that may operate in response to a signal or the like. The walking assist apparatus may brake the wheel part in a situation (e.g., red light) in which the pedestrian cannot walk in response to a signal or the like, thereby providing the function of supporting the safety of the pedestrian.

According to the embodiments of the present invention described above, it is possible to implement the walking assist apparatus capable of ensuring the convenience of use and safety and having significant advantages in terms of logistical movements, accommodation, and storage. The walking assist apparatus according to the embodiments has the two-step foldable structure, i.e., the structure capable of being folded twice, which may provide many advantages in terms of logistical movements such as shipping, delivery, and transportation and enable compact accommodation/storage even from the point of view of the user. Further, the walking assist apparatus according to the embodiments may provide excellent convenience of use and safety.

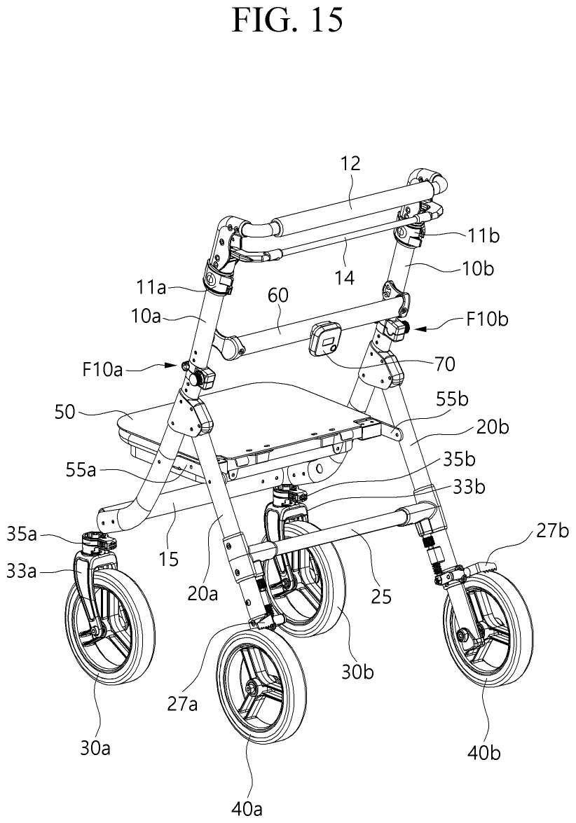

The exemplary embodiments of the present invention have been disclosed in the present specification, and specific terms are used, but the specific terms are used as general meanings merely for easily explaining the technical contents of the present invention and helping understand the present invention, but not intended to limit the scope of the present invention. It is obvious to those skilled in the art to which the present invention pertains that other modified embodiments may be carried out based on the technical spirit of the present invention in addition to the exemplary embodiments disclosed herein. For example, those skilled in the art may recognize that the walking assist apparatus according to the embodiments described with reference to FIGS. 1 to 15 may be modified variously. Therefore, the scope of the present invention should be determined by the technical spirit of the appended claims instead of being determined by the described embodiment.

What is claimed is:

1. A two-step foldable walking assist apparatus comprising:
first and second main frames spaced apart from each other, extending in parallel with each other in an upward/downward direction, and each having an inclined structure inclined rearward;
first and second rear support frames respectively coupled to middle portions of the first and second main frames, extending downward in parallel with each other, and each having an inclined structure inclined forward;
a handle part provided to be connected to upper ends of the first and second main frames;
first and second front wheel parts coupled to lower ends of the first and second main frames or portions adjacent to the lower ends of the first and second main frames;
first and second rear wheel parts coupled to lower ends of the first and second rear support frames or portions adjacent to the lower ends of the first and second rear support frames;
a seat member installed between the first and second main frames and connected to all the first and second main frames and the first and second rear support frames; and
first and second folding parts disposed at positions higher than the first and second rear support frames and respectively provided on the first and second main frames,
wherein the two-step foldable walking assist apparatus is configured to be folded by raising a front portion of the seat member and allowing lower portions of the first and second main frames and lower portions of the first and second rear support frames to move toward one another, and
wherein the first and second main frames are configured to be folded forward and downward at the first and second folding parts.

2. The two-step foldable walking assist apparatus of claim 1, comprising:
a first connection member coupled to the first main frame and the first rear support frame to connect the first main frame and the first rear support frame; and
a second connection member coupled to the second main frame and the second rear support frame to connect the second main frame and the second rear support frame,
wherein the seat member is coupled to the first and second connection members and disposed between the first and second connection members.

3. The two-step foldable walking assist apparatus of claim 1, wherein the first folding part comprises:
a lower assembling member;
an upper assembling member coupled to the lower assembling member by a rotary shaft member and provided to be rotatable about the rotary shaft member relative to the lower assembling member; and
a clutch member installed on the lower assembling member and structurally coupled to a part of the upper assembling member, the clutch member being configured to restrict or allow a rotational motion of the upper assembling member,
wherein the first main frame is configured to be folded at the first folding part by a rotation of the upper assembling member, and
wherein the second folding part and the first folding part have the same configuration or a symmetric configuration.

4. The two-step foldable walking assist apparatus of claim 1, further comprising:
a brake lever disposed below the handle part and connected to at least one of the first and second main frames, the brake lever being configured to brake at least one of the first and second rear wheel parts,
wherein the brake lever performs a hand brake function while the two-step foldable walking assist apparatus travels, and the brake lever performs a parking brake function while the two-step foldable walking assist apparatus is parked.

5. The two-step foldable walking assist apparatus of claim 1, further comprising:
a storage member disposed below the seat member and made of a flexible material.

6. The two-step foldable walking assist apparatus of claim 1, further comprising:
steering adjustment members configured to control rotation ranges for steering the first and second front wheel parts; and
a backrest connection frame disposed between the seat member and the handle part and configured to connect the first and second main frames.
